(19) United States
(12) Patent Application Publication
(10) Pub. No.: US 2008/0296187 A1
(43) Pub. Date: Dec. 4, 2008

(54) TOOL BIT CADDY AND METHOD OF OPERATING THE SAME

(76) Inventors: Robert W. Butzen, Colgate, WI (US); Michael W. Kirby, Mequon, WI (US); Richard Hohnl, JR., Racine, WI (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/130,180

(22) Filed: May 30, 2008

Related U.S. Application Data
(60) Provisional application No. 60/932,747, filed on Jun. 1, 2007.

(51) Int. Cl. B65D 85/00; B65D 25/04; B65D 25/54; B65D 3/02; B65G 59/06

(52) U.S. Cl. 206/379; 220/507; 220/662; 220/669; 221/22

(57) ABSTRACT

A bit caddy includes a first housing part having a central axis extending therethrough. The first housing part includes a surface extending from an interior to an outer perimeter. The surface is sloped at an obtuse angle relative to the central axis. The first housing part also includes a plurality of walls radially extending from the interior toward the outer perimeter and a plurality of storage pockets. Each storage pocket is configured to support a bit and is defined by the surface and two adjacent walls of the plurality of walls. The bit caddy also includes a second housing part rotatably coupled to the first housing part for rotation relative to the first housing part about the central axis. The second housing part defines an opening for dispensing a bit from one of the plurality of storage pockets.

### CROSS-REFERENCE TO RELATED APPLICATIONS

This application claims priority to U.S. Provisional Patent Application No. 60/932,747, filed Jun. 1, 2007, the entire contents of which are hereby incorporated by reference.

### BACKGROUND

The present invention relates to a caddy and, more particularly, to a caddy for displaying, dispensing, and/or storing tool bits.

### SUMMARY

In some embodiments, the invention provides a bit caddy including a first housing part having a central axis extending therethrough. The first housing part includes a surface extending from an interior to an outer perimeter. The surface is sloped at an obtuse angle relative to the central axis. The first housing part also includes a plurality of walls radially extending from the interior toward the outer perimeter and a plurality of storage pockets. Each storage pocket is configured to support a bit and is defined by the surface and two adjacent walls of the plurality of walls. The bit caddy also includes a second housing part rotatably coupled to the first housing part for rotation relative to the first housing part about the central axis. The second housing part defines an opening for dispensing a bit from one of the plurality of storage pockets.

In other embodiments, the bit caddy includes a first housing part having a plurality of storage pockets. Each storage pocket is configured to support a bit. The first housing part also includes a plurality of markings indicative of at least one of a type and a size of a bit within adjacent storage pockets. The bit caddy also includes a second housing part movably coupled to the first housing part. The second housing part defines a first opening for dispensing a bit supported by one of the plurality of storage pockets and a second opening designating one of the plurality of markings on the first housing part that corresponds to the bit currently aligned with the first opening.

In further embodiments, the invention provides a caddy housing for dispensing a bit caddy. The caddy housing includes a first sleeve defining an interior between an upper end and a lower end. The first sleeve is configured to house a plurality of bit caddies within the interior. The caddy housing also includes a second sleeve coupled to the lower end of the first sleeve. The second sleeve includes an opening in communication with the interior of the first sleeve. The opening facilitates removal of the bit caddy from the caddy housing. The second sleeve also includes a sloped surface adjacent to the opening. The sloped surface is configured to orient the bit caddy such that an upper portion of the bit caddy is visible through the opening.

Other aspects of the invention will become apparent by consideration of the detailed description and accompanying drawings.

### BRIEF DESCRIPTION OF THE DRAWINGS

FIG. 1 is a front perspective view of a bit caddy according to some embodiments of the present invention.

FIG. 2 is a top view of the bit caddy shown in FIG. 1.

FIG. 3 is a side view of the bit caddy shown in FIG. 1.

FIG. 4 is a bottom perspective view of the bit caddy shown in FIG. 1.

FIG. 5 is a bottom view of the bit caddy shown in FIG. 1.

FIG. 6 is an enlarged bottom view of a first housing part of the bit caddy shown in FIG. 1.

FIG. 7 is a bottom perspective view of a second housing part of the bit caddy shown in FIG. 1.

FIG. 8 is a top perspective view of the first housing part of the bit caddy shown in FIG. 1.

FIG. 9 is an exploded perspective view of the bit caddy shown in FIG. 1.

FIG. 10A is an enlarged exploded perspective view of the bit caddy shown in FIG. 1.

FIG. 10B is another enlarged exploded perspective view of the bit caddy shown in FIG. 1.

FIG. 11 is an enlarged cross-sectional view of the bit caddy shown in FIG. 1.

FIG. 12 is a perspective view of a caddy housing.

FIG. 13 is an exploded perspective view of the caddy housing shown in FIG. 12.

FIG. 14 is a front view of the caddy housing shown in FIG. 12.

FIG. 15 is a side view of the caddy housing shown in FIG. 12.

FIG. 16 is a rear view of the caddy housing shown in FIG. 12.

FIG. 17 is a top view of a caddy according to another embodiment of the present invention.

FIG. 18 is a side view of the caddy shown in FIG. 17.

FIG. 19 is a bottom view of the caddy shown in FIG. 17.

FIG. 20 is a front perspective view of a caddy according to yet another embodiment of the present invention.

FIG. 21 is another front perspective view of the caddy shown in FIG. 20.

FIG. 22 is a side view of the caddy shown in FIG. 20.

FIG. 23 is a top view of the caddy shown in FIG. 20.

FIG. 24 is a rear perspective view of the caddy shown in FIG. 20.

FIG. 25 is a front view of a caddy housing according to some embodiments of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” and “having” and variations thereof herein is meant to encompass the items listed thereafter and equivalents thereof as well as additional items.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In addition, it is to be understood that phraseology and terminology used herein with reference to device or element orientation (such as, for example, terms like “front,” “rear,” “top,” “bottom,” “lower”, “up,” “down,” etc.) are only used to simplify description of the present invention, and do not alone indicate or imply that the device or element referred to must have a particular orientation. The elements of the present invention can be installed and operated in any orientation desired. In addition, terms such as “first” and “second” are used herein for purposes of description and are not intended to indicate or imply relative importance or significance.

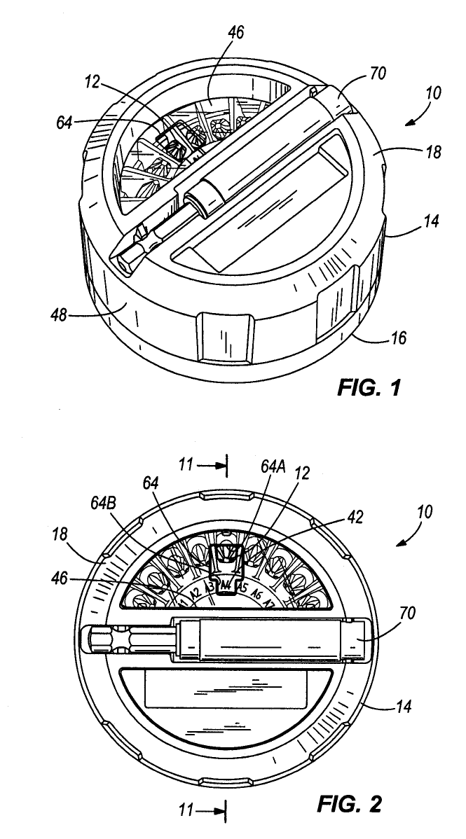

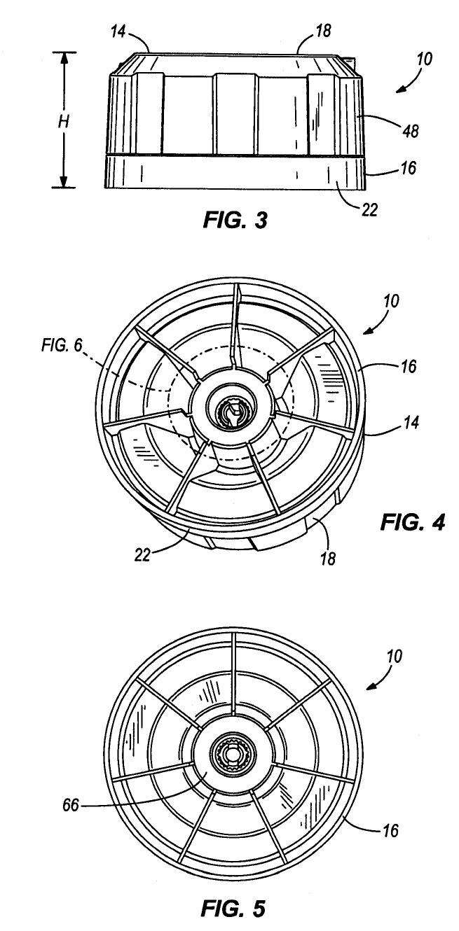

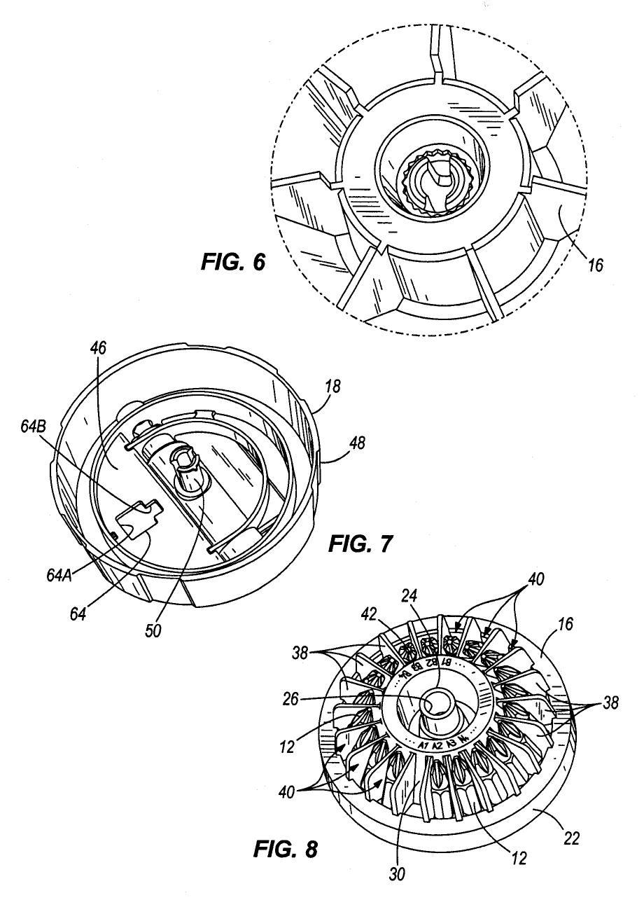

FIGS. 1-11 illustrate a caddy 10 for housing, dispensing, and/or displaying a number of screwdriver bits 12. In other embodiments, the caddy 10 can also or alternatively house, dispense, and/or display other bits, including drill bits, auger bits, boring bits, flat head drill bits, twist drill bits, step drill bits, masonry bits, carbide-tip bits, and the like. In the illustrated embodiment, the caddy 10 can house as many as twenty bits 12. In other embodiments, the caddy 10 can house other numbers of bits 12.

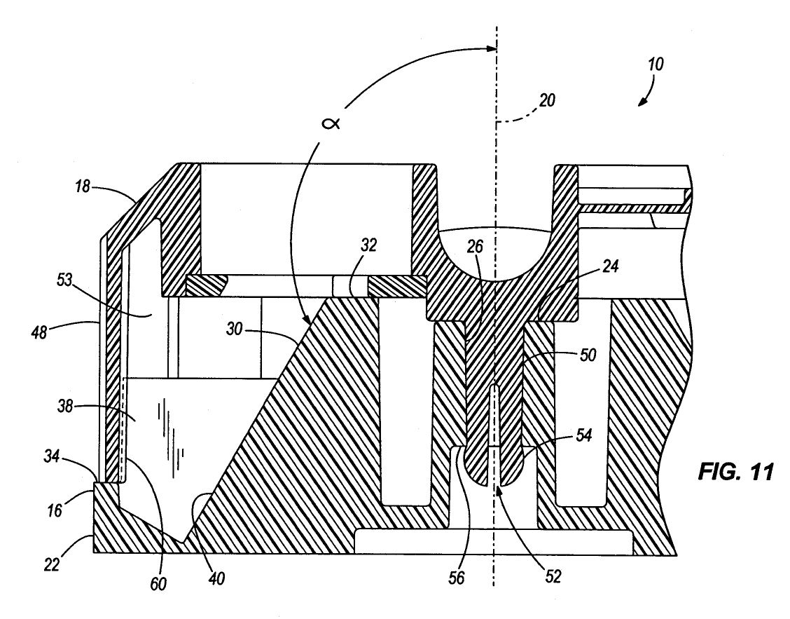

As shown in FIGS. 1-11, the bit caddy 10 can include a housing assembly 14 formed from a first housing part 16 and a second housing part 18, which can be secured to the first housing part 16 for rotating movement relative to the first housing part 16 about a central axis 20 (shown in FIG. 11) to display and/or dispense bits 12 supported in the bit caddy 10. In some embodiments, such as the illustrated embodiment of FIGS. 1-11, the housing assembly 14 can have a generally circular cross-sectional shape and can have substantially planar upper and lower surfaces. In other embodiments, the housing assembly 14 can have other shapes and configurations, such as, for example, oval, rectangular or other polygon, or irregular cross-sectional shapes. Alternatively or in addition, the housing assembly 14 can include a convex or concave upper surface.

As shown in FIGS. 3, 4, and 8-10B, the first housing part 16 can have a substantially smooth outer surface 22. In other embodiments, the outer surface 22 can be textured to provide an improved gripping surface. In yet other embodiments, the outer surface 22 can include finger-shaped depressions or recesses to provide an improved gripping surface.

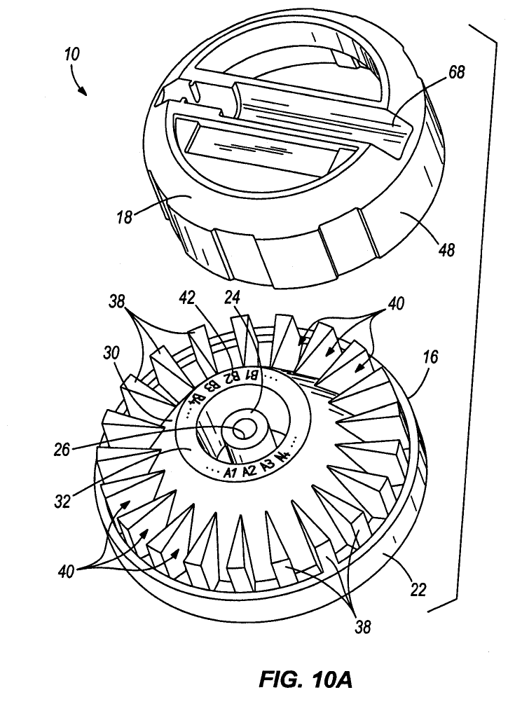

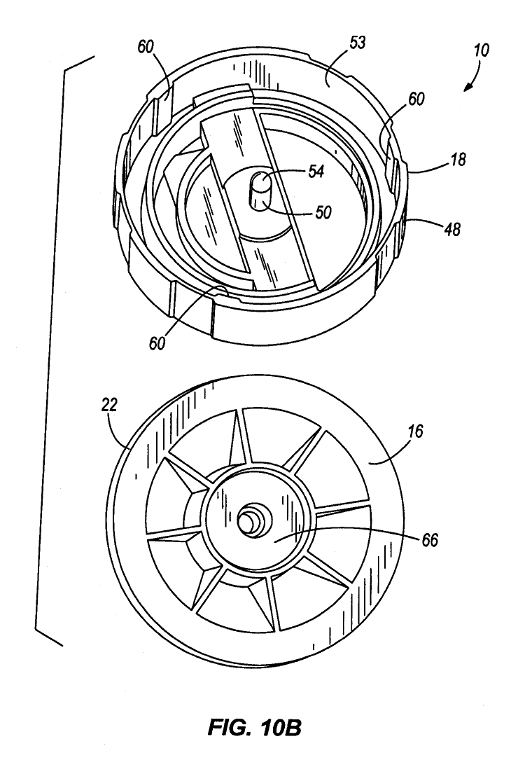

In some embodiments, such as the illustrated embodiment of FIGS. 1-11, the first housing part 16 can include an upwardly extending protrusion 24 (FIGS. 8-10A) positioned at an approximate center of the first housing part 16 and at least partially defining the central axis 20. As shown in FIGS. 10A-11, the protrusion 24 can include a central opening 26.

The first housing part 16 can also include a display surface 30 sloping downwardly from an inner edge 32, or interior, toward an outer perimeter 34. In the illustrated embodiment of FIGS. 1-11, the display surface 30 extends from an interior location radially spaced apart from the central axis 20. In other embodiments, the surface 30 can extend outwardly from other interior locations, such as, for example, an approximate center of the first housing part 16, a location positioned outwardly from the approximate center, or the like. In some embodiments, the display surface 30 can be oriented at an obtuse angle a of between about 110 degrees and about 170 degrees with respect to the central axis 20. In the illustrated embodiment, the display surface 30 is oriented at an angle a of about 120 degrees with respect to the central axis 20.

As shown in FIGS. 1-11, the display surface 30 can be integrally formed with or secured to the first housing part 16. In other embodiments, the display surface 30 can be secured to or integrally formed with the second housing part 18. In yet other embodiments, the display surface 30 can be positioned between the first and second housing parts 16, 18.

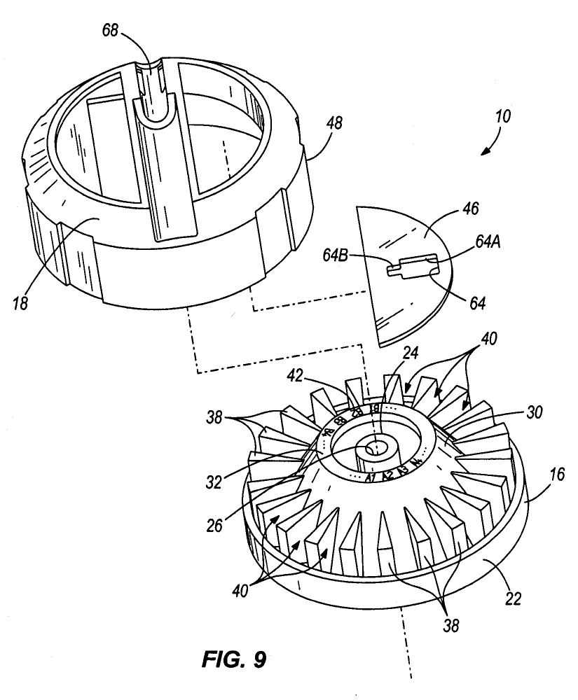

In some embodiments, such as the illustrated embodiment of FIGS. 1-11, the first housing part 16 can include a number of radially extending walls 38 at least partially defining a number of bit storage pockets 40. As shown in FIG. 8, the walls 38 extend outwardly from the display surface 30 toward the outer perimeter 34 and outwardly toward the underside of the second housing part 18. In other embodiments, the display surface 30 can be generally planar and can include storage pockets 40 formed in the planar display surface 30. As shown in FIGS. 9 and 10A, the inner edge 32 of the display surface 30 can include markings 42 indicative of the size and/or type of bits 12 stored in the adjacent storage pockets 40. In some embodiments, the markings 42 can match markings provided on the bits 12 so that an operator can more easily return a bit 12 to the appropriate storage pocket 40 after removing the bit 12 from the caddy 10.

In some embodiments, such as the illustrated embodiment of FIGS. 1-11, in which the display surface 30 is sloped with respect to the central axis 20, the caddy 10 can have a shorter height H (measured along the central axis 20) than embodiments in which the bits 12 stored in the storage pockets 40 are substantially parallel to the central axis 20. Moreover, in embodiments, such as the illustrated embodiment of FIGS. 1-11, in which the display surface 30 is sloped with respect to the central axis 20, a substantial portion of one or more of the bits 12 supported in the storage pockets 40 is visible through a viewing window 46 provided in the second housing part 18 so that an operator can more easily select the appropriate bit 12 for a job. In such embodiments, an operator can view the heads of the bits 12 through the window 46 such that, for example, the operator can see whether a particular bit 12 has a large flat screwdriver head or a small Phillips head.

As shown in FIGS. 1-4, 7, and 9-10B, the second housing part 18 can include a contoured outer surface 48 such that an operator can more easily grip the second housing part 18 and can more easily rotate the second housing part 18 relative to the first housing part 16 about the axis 20. As shown in FIGS. 10B and 11, the second housing part 18 can also include a protrusion 50 extending inwardly from an upper surface into an interior space 53 defined between the first and second housing parts 16, 18.

In the illustrated embodiment of FIGS. 1-11, the protrusion 50 includes a central slot 52 and a radially outwardly extending outer end 54. To assemble the caddy 10, the protrusion 50 of the second housing part 18 is inserted into the opening 26 defined in the protrusion 24 of the first housing part 16. During insertion, the outer end 54 of the protrusion 50 is compressed radially inwardly to allow the outer end 54 to move past a radially inwardly extending rib 56 positioned in the opening 26 in the first housing part 16. Once the outer end 54 of the protrusion 50 is moved downwardly along the central axis 20 beyond the rib 56, the outer end 54 expands radially and the outer end 54 lockingly engages the rib 56, securing the second housing part 18 to the first housing part 16.

In other embodiments, the first and second housing parts 16, 18 can be connected using other connectors and fastening arrangements. For example, in some such embodiments, a threaded fastener is inserted through openings in both the first and second housing parts 16, 18. In still other embodiments, the first and second housing parts 16, 18 can include inter-engaging protrusions and recesses formed around the outer peripheries of the first and second housing parts 16, 18 which lockingly secure the first and second housing parts 16, 18 together and which allow the second housing part 18 to be rotated about the central axis 20 with respect to the first housing part 16.

The second housing part 18 can also include inwardly extending detents 60 (FIG. 10B), which are selectively engageable with the radially extending walls 38 of the first housing part 16 to inhibit unintentional rotation of the second housing part 18 about the central axis 20 with respect to the first housing part 16.

In some embodiments, such as the illustrated embodiment of FIGS. 1-11, the second housing part 18 can also include a viewing window 46, which allows an operator to view one or more bits 12 supported in the storage pockets 40 without having to remove the bits 12 from the caddy 10. In the illustrated embodiment of FIGS. 1-11, the window 46 is supported in the second housing part 18 and extends around approximately 180 degrees of the upper surface of the second housing part 18. As shown in FIG. 1, the window 46 can also or alternatively be recessed with respect to the upper surface of the second housing part 18.

As shown in FIGS. 1, 2, 7, and 9, the second housing part 18 can also include a dispensing opening 64. The dispensing opening 64 can be formed in the window 46 so that an operator can view a selected bit 12 and then dispense the bit 12. In some embodiments, such as the illustrated embodiment of FIGS. 1-11, the viewing window 46 also allows an operator to view one or more bits 12 adjacent to the bit 12 under the dispensing opening 64 so that the operator can select the most appropriate bit 12 for a job. As shown in FIG. 2, the dispensing opening 64 includes a first portion 64A for dispensing a bit from the caddy 10 and a second portion 64B for designating the marking 42 that corresponds to the bit 12 aligned with the dispensing opening 64. In the illustrated embodiment, the first and second portions 64A, 64B are in communication with one another such that the opening 64 is a single opening. In other embodiments, the first and second portions 64A, 64B may be distinct openings and may be positioned on different surfaces of the second housing part 18.

In some embodiments, such as the illustrated embodiment of FIGS. 1-11, the detents 60 and the walls 38 can be oriented such that a single incremental movement of the second housing part 18 relative to the first housing part 16 causes the dispensing opening 64 to move from alignment with one storage pocket 40 into alignment with an adjacent storage pocket 40.

The housing assembly 14 can also or alternatively include a magnet 66 (FIGS. 5 and 10B) for picking up, collecting, and/or locating bits, fasteners, metal shavings, and the like. Alternatively or in addition, the magnet 66 can be used to secure the caddy 10 to a metal structure, a tool box, or a vehicle.

In the illustrated embodiment, the magnet 66 is secured to the underside of the first housing part 16 and is positioned at a center of the underside of the first housing part 16. In other embodiments, the magnet 66 can be positioned on an outer periphery of the first or second housing parts 16, 18, on the upper surface of the second housing part 18, or in the interior of the caddy 10 between the first and second housing parts 16, 18. In still other embodiments, the caddy 10 can include two or more magnets 66.

As shown in FIGS. 1, 2, 9, and 10A, the caddy 10 can also include a tool storage recess 68 for storing a tool 70, such as, for example, a bit extension, a bit adapter, a screw guide, and the like. In the illustrated embodiment, a tool storage recess 68 is formed in the upper surface of the second housing part 18 adjacent to the window 46. As shown in FIGS. 9 and 10A, the tool storage recess 68 can be contoured to closely engage the tool 70 and to prevent the tool 70 from falling out of the storage recess 68. In other embodiments, the caddy 10 can include two or more tool storage recesses 68 located on the upper surface of the second housing part 18, the lower surface of the first housing part 16, the outer surface of the second housing part 18, or in the interior of the caddy 10 between the first and second housing parts 16, 18.

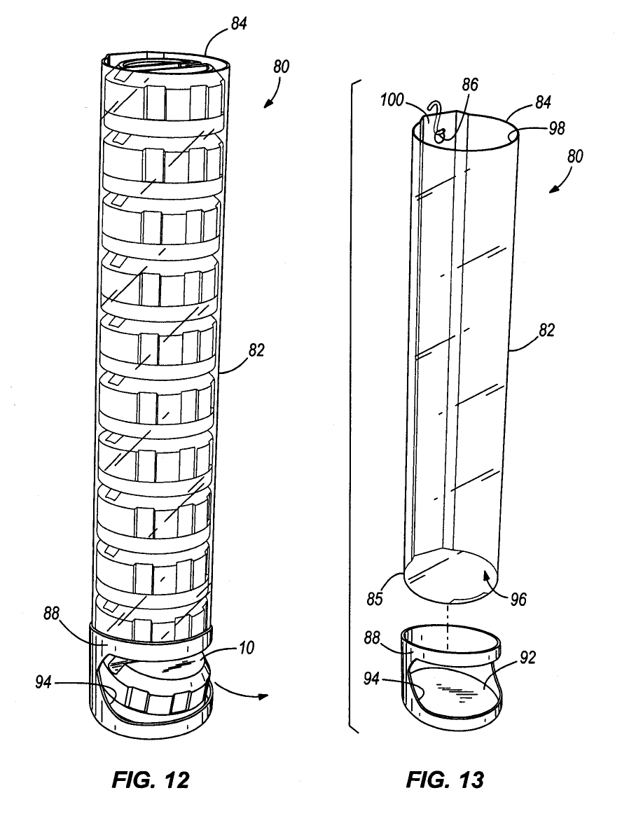

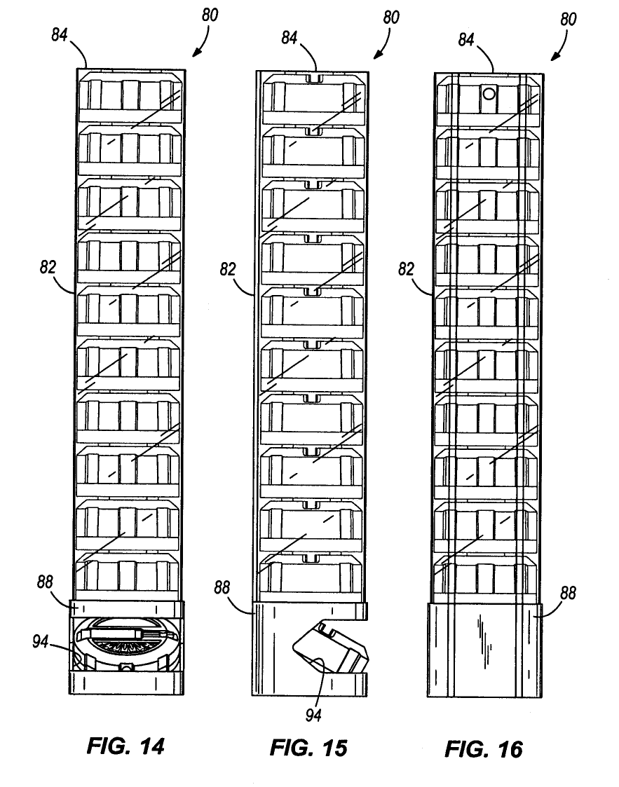

FIGS. 12-16 illustrate a caddy housing 80 for housing, dispensing, and/or displaying a number of caddies 10. In the illustrated embodiment of FIGS. 12-16, the housing 80 includes a first sleeve 82, which can be formed of a transparent or translucent material, having an upper end 84 and a lower end 85. As shown in FIG. 13, the upper end 82 of the first sleeve 82 can include a hanger 86. The housing 80 can also or alternatively include a second sleeve 88 secured to the lower end 85 of the first sleeve 82.

As shown in FIGS. 12-16, the second sleeve 88 can include a sloped lower surface 92 and an opening 94 communicating with an interior 96 of the housing 80. As shown in FIGS. 12, 14, and 15, the sloped surface 92 ensures that the upper portion of the caddy 10 is visible through the opening 94 in the second sleeve 88.

In the illustrated embodiment, the first sleeve 82 has a cross-section including a generally circular portion 98 and a generally rectangular nose portion 100 positioned radially outward from the circular portion 98. The nose portion 100 opens into the circular portion 98 to provide additional clearance in the first sleeve 82 such that, when a bit caddy 10 slides into the second sleeve 88, the bit caddy 10 can tip or pivot relative to the housing 80. In other embodiments, the first sleeve 82 may have a differently-shaped cross-section to accommodate differently-shaped bit caddies (e.g., oval, rectangular, or the like) and to provide clearance for tipping the bit caddy.

In the illustrated embodiment of FIGS. 12-16, the caddies 10 are removable from the housing 80 through the opening 94. When a caddy 10 is removed from the opening 94, another caddy 10 moves axially downwardly through from the first sleeve 82 onto the lower surface 92.

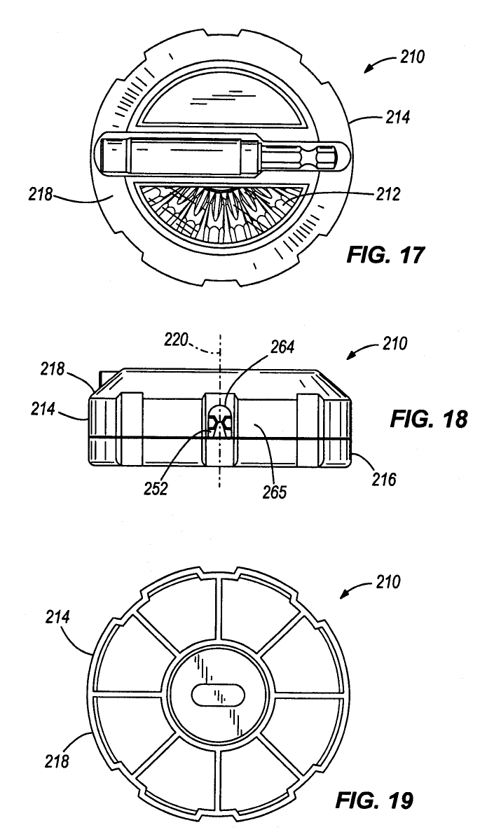

FIGS. 17-19 illustrate another embodiment of a caddy 210 according to the present invention. The caddy 210 shown in FIGS. 17-19 is similar in many ways to the illustrated embodiments of FIGS. 1-11 described above. Accordingly, with the exception of mutually inconsistent features and elements between the embodiment of FIGS. 17-19 and the embodiments of FIGS. 1-11, reference is hereby made to the description above accompanying the embodiments of FIGS. 1-11 for a more complete description of the features and elements (and the alternatives to the features and elements) of the embodiment of FIGS. 17-19. Features and elements in the embodiment of FIGS. 17-19 corresponding to features and elements in the embodiments of FIGS. 1-11 are numbered in the 200 series.

As shown in FIGS. 17-19, the caddy 210 can include a housing assembly 214 formed from a first housing part 216 and a second housing part 218, which can be secured to the first housing part 216 for rotating movement relative to the first housing part 218 about a central axis 220 to display and/or dispense different bits 212 supported in the bit caddy 210. The caddy 210 can also include a dispense opening 264 extending through a side wall 265 of the second housing part 218 for dispensing bits 212 housed in an interior 252 of the caddy 210.

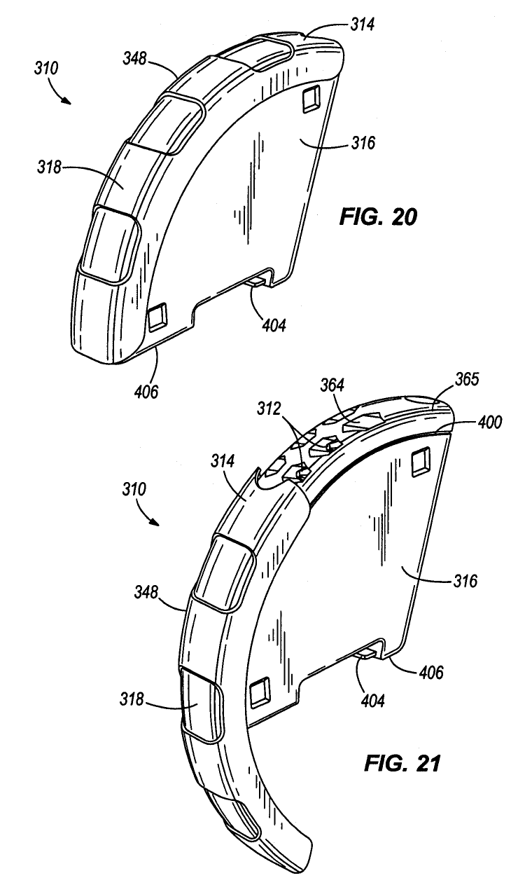

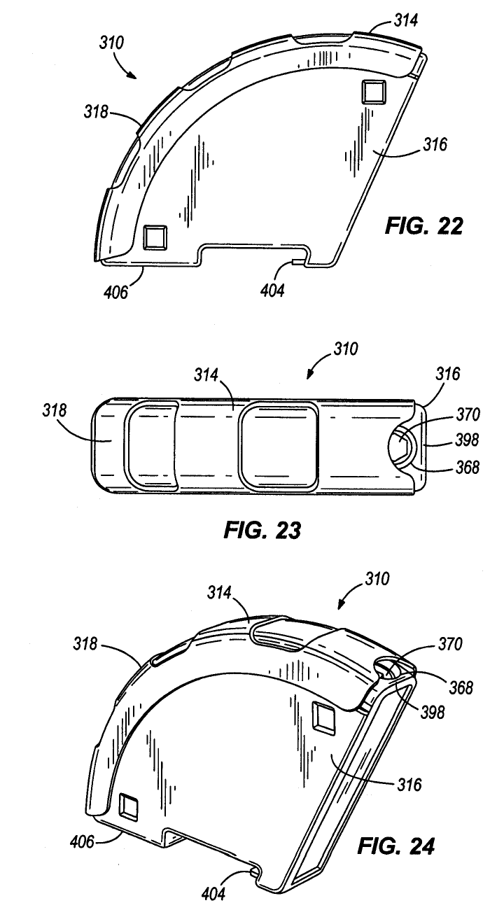

FIGS. 20-24 illustrate another embodiment of a caddy 310 according to the present invention. The caddy 310 shown in FIGS. 20-24 is similar in many ways to the illustrated embodiments of FIGS. 1-11 and 17-19 described above. Accordingly, with the exception of mutually inconsistent features and elements between the embodiment of FIGS. 20-24 and the embodiments of FIGS. 1-11 and 17-19, reference is hereby made to the description above accompanying the embodiments of FIGS. 1-11 and 17-19 for a more complete description of the features and elements (and the alternatives to the features and elements) of the embodiment of FIGS. 20-24. Features and elements in the embodiment of FIGS. 20-24 corresponding to features and elements in the embodiments of FIGS. 1-11 and 17-19 are numbered in the 300 series.

FIGS. 20-24 illustrate a caddy 310 for housing, dispensing, and/or displaying a number of bits 312. The caddy 310 can include a housing assembly 314 having a first housing part 316. A number of dispense openings 364 extend through an outer wall 365 of the first housing part 316 for supporting and dispensing bits 312. As shown in FIGS. 23 and 24, a tool storage recess 368 extends through a first end 398 of the outer wall 365 and can support a tool 370, such as, for example, a bit extension, a bit adapter, a screw guide, or the like.

In the illustrated embodiment of FIGS. 20-24, the housing assembly 314 also includes a generally arcuately-shaped second housing part 318 having a contoured outer surface 348 such that an operator can more easily grip the second housing part 318 and can more easily move the second housing part 318 along the outer wall 365 of the first housing part 316 between a closed position (shown in FIGS. 20 and 22-24) and opened positions (one of which is shown in FIG. 21). The second housing part 318 can also include inwardly extending rails which are engageable with and moveable along tracks 400 formed on opposite sides of the first housing part 316 adjacent to the outer wall 365 of the first housing part 316.

The first housing part 316 can also or alternatively include a magnet (not shown) for picking up, collecting, and/or locating bits, fasteners, metal shavings, and the like. Alternatively or in addition, the magnet can be used to secure the caddy 310 to a metal structure, a tool box, or a vehicle. In some embodiments, such as the illustrated embodiment of FIGS. 20-24, the magnet can be housed in the first housing part 316 adjacent to a rear side 402 of the first housing part 316. As shown in FIGS. 20-22 and 24, the caddy 310 can also include a bottle opener 404 formed on a bottom side 406 of the first housing part 316.

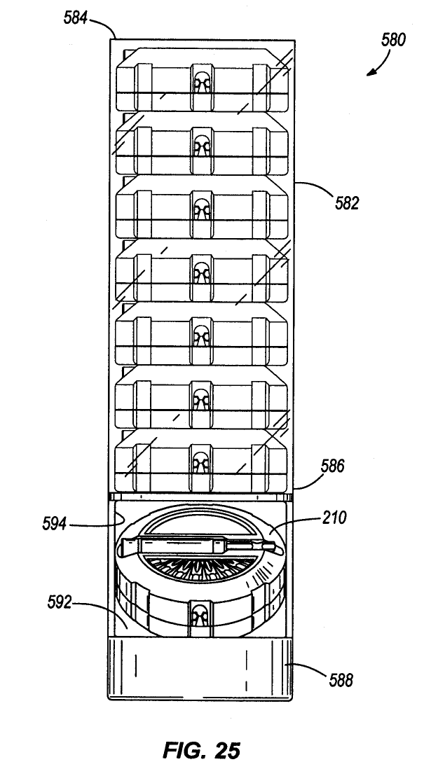

FIG. 25 illustrates another embodiment of a caddy housing 580 according to the present invention. The housing 580 shown in FIG. 25 is similar in many ways to the illustrated embodiments of FIGS. 12-16 described above. Accordingly, with the exception of mutually inconsistent features and elements between the embodiment of FIG. 25 and the embodiments of FIG. 12-16, reference is hereby made to the description above accompanying the embodiments of FIGS. 12-16 for a more complete description of the features and elements (and the alternatives to the features and elements) of the embodiment of FIG. 25. Features and elements in the embodiment of FIG. 25 corresponding to features and elements in the embodiments of FIGS. 12-16 are numbered in the 500 series.

FIG. 25 illustrates a caddy housing 580 for housing, dispensing, and/or displaying a number of caddies 210. In the illustrated embodiment of FIG. 25, the housing 580 includes a first sleeve 582, which can be formed of a transparent or translucent material, having an upper end 584 and a lower end 586. The housing 580 can also or alternatively include a second sleeve 588 secured to the lower end 586 of the first sleeve 582.

As shown in FIG. 25, the second sleeve 588 can include a sloped lower surface 592 and an opening 594 communicating with an interior of the housing 580. As shown in FIG. 25, the sloped surface 592 ensures that the upper portion of the caddy 210 is visible through the opening 594 in the second sleeve 588.

In the illustrated embodiment of FIG. 25, the caddies 210 are removable from the housing 580 through the opening 594. When a caddy 210 is removed from the opening 594, another caddy 210 moves axially downwardly through from the first sleeve 582 onto the lower surface 592.

Although particular embodiments of the present invention have been shown and described, other alternative embodiments will be apparent to those skilled in the art and are within the intended scope of the present invention.

1. A bit caddy comprising:
a first housing part having a central axis extending therethrough, the first housing part including
a surface extending from an interior to an outer perimeter, the surface being sloped at an obtuse angle relative to the central axis,
a plurality of walls radially extending from the interior toward the outer perimeter, and
a plurality of storage pockets, each storage pocket configured to support a bit and being defined by the surface and two adjacent walls of the plurality of walls; and
a second housing part rotatably coupled to the first housing part for rotation relative to the first housing part about the central axis, the second housing part defining an opening for dispensing a bit from one of the plurality of storage pockets.

2. The bit caddy of claim 1, wherein the surface is downwardly sloped from the interior toward the outer perimeter.

3. The bit caddy of claim 1, wherein the obtuse angle is between about 110 degrees and 170 degrees.

4. The bit caddy of claim 3, wherein the obtuse angle is about 120 degrees.

5. The bit caddy of claim 1, wherein the second housing part rotates relative to the first housing part to move the opening from alignment with one of the plurality of storage pockets into alignment with another one of the plurality of storage pockets.

6. The bit caddy of claim 1, wherein at least one of the first housing part and the second housing part includes a detent extending inwardly toward the central axis, and wherein the detent selectively engages a portion of the other of the first housing part and the second housing part to inhibit rotation of the second housing part relative to the first housing part.

7. The bit caddy of claim 6, wherein the detent selectively engages at least some of the plurality of walls to inhibit rotation of the second housing part relative to the first housing part.

8. The bit caddy of claim 1, further comprising a storage recess formed in one of the first housing part and the second housing part, wherein the storage recess is configured to receive a tool.

9. The bit caddy of claim 1, wherein the second housing part includes a substantially transparent window such that at least some of the bits supported by the plurality of storage pockets are visible through the substantially transparent window.

10. The bit caddy of claim 9, wherein the opening is formed in the substantially transparent window.

11. The bit caddy of claim 1, wherein the first housing part includes a first protrusion and the second housing part includes a second protrusion, wherein one of the first protrusion and the second protrusion receives a portion of the other of the first protrusion and the second protrusion to rotatably couple the second housing part to the first housing part, and wherein the central axis extends through the first and second protrusions.

12. The bit caddy of claim 1, wherein the first housing part includes a plurality of markings indicative of at least one of a type and a size of a bit within adjacent storage pockets, and wherein at least one of the plurality of markings is visible through the opening in the second housing part.

13. A bit caddy comprising:
a first housing part including
a plurality of storage pockets, each storage pocket configured to support a bit, and
a plurality of markings indicative of at least one of a type and a size of a bit within adjacent storage pockets; and
a second housing part movably coupled to the first housing part, the second housing part defining a first opening for dispensing a bit supported by one of the plurality of storage pockets and a second opening designating one of the plurality of markings on the first housing part that corresponds to the bit currently aligned with the first opening.

14. The bit caddy of claim 13, wherein the second housing part moves relative to the first housing part to align the first opening with a bit supported by another one of the plurality of storage pockets and the second opening with another one of the plurality of markings.

15. The bit caddy of claim 13, wherein the first opening is in communication with the second opening to form a single opening.

16. The bit caddy of claim 13, wherein the second housing part is rotatably coupled to the first housing part for rotation relative to the first housing part about a central axis extending through the first housing part and the second housing part.

17. The bit caddy of claim 13, wherein the second housing part includes a substantially transparent window such that at least some of the bits supported by the plurality of storage pockets are visible through the substantially transparent window.

18. The bit caddy of claim 17, wherein the substantially transparent window is recessed relative to an outer surface of the second housing part.

19. The bit caddy of claim 17, wherein at least one of the first opening and the second opening is formed in the substantially transparent window.

20. The bit caddy of claim 13, wherein the second housing part includes a contoured outer surface to facilitate movement of the second housing part relative to the first housing part.

21. The bit caddy of claim 13, further comprising a magnet coupled to one of the first housing part and the second housing part.

22. The bit caddy of claim 13, further comprising a storage recess formed in one of the first housing part and the second housing part, wherein the storage recess is configured to receive a tool.

23. The bit caddy of claim 13, wherein the first housing part includes an interior and an outer perimeter, and wherein the plurality of markings is located on the interior.

24. The bit caddy of claim 23, wherein the first housing part includes a surface extending from the interior toward the outer perimeter and partially defining the plurality of storage pockets, and wherein the surface downwardly slopes from the interior to the outer perimeter.

25. The bit caddy of claim 13, wherein one of the first housing part and the second housing part includes a detent, and wherein the detent selectively engages a portion of the other of the first housing part and the second housing part to inhibit rotation of the second housing part relative to the first housing part.

26. The bit caddy of claim 13, wherein the first housing part includes a plurality of walls radially extending from the interior toward the outer perimeter, and wherein the plurality of walls at least partially define the plurality of storage pockets.

27. A caddy housing for dispensing a bit caddy, the caddy housing comprising:
a first sleeve defining an interior between an upper end and a lower end, the first sleeve configured to house a plurality of bit caddies within the interior; and
a second sleeve coupled to the lower end of the first sleeve, the second sleeve including
an opening in communication with the interior of the first sleeve, the opening facilitating removal of the bit caddy from the caddy housing, and
a sloped surface adjacent to the opening, the sloped surface configured to orient the bit caddy such that an upper portion of the bit caddy is visible through the opening.

28. The caddy housing of claim 27, further comprising a hanger coupled to one of the first sleeve and the second sleeve, wherein the hanger is configured to engage a support structure to support the caddy housing from the support structure.

29. The caddy housing of claim 27, wherein the first sleeve is formed of a substantially transparent material.

30. The caddy housing of claim 27, wherein, when the bit caddy is removed through the opening in the second sleeve, one of the plurality of bit caddies within the interior of the first sleeve moves downwardly onto the sloped surface of the second sleeve.

31. The caddy housing of claim 30, wherein, when the bit caddy is removed, the one of the plurality of bit caddies pivots relative to the caddy housing such that an upper portion of the one of the plurality of caddies is visible through the opening in the second sleeve.

32. The caddy housing of claim 27, wherein the first sleeve is substantially tubular, and wherein the plurality of bit caddies are configured to stack within the interior of the first sleeve.

33. The caddy housing of claim 27, wherein the first sleeve has a cross-section including a first portion generally corresponding to a shape and size of an exterior of the bit caddy and a second portion positioned radially outward from and opening into the first portion.

34. The caddy housing of claim 27, wherein at least one bit supported in the bit caddy is visible through the opening in the second sleeve when the bit caddy is supported on the sloped surface.
